(19) United States
(12) Patent Application Publication
(10) Pub. No.: US 2026/0154965 A1
(43) Pub. Date: Jun. 4, 2026

(54) DEVICE AND METHOD FOR PROVIDING A SECURITY ALERT IN RESPONSE TO AN OBJECT CROSSING A SECURITY PERIMETER

(71) Applicant: MOTOROLA SOLUTIONS, INC., CHICAGO, IL (US)

(72) Inventors: KIOK YUNG LEE, NIBONG TEBAL (MY); NGUK SING WONG, SEBERANG JAYA (MY); JOO YIH SEE, ALOR SETAR (MY); CHENG YAU LEE, BAYAN LEPAS (MY)

(21) Appl. No.: 18/956,328

(22) Filed: Nov. 22, 2024

(51) Int. Cl. G06V 20/52; G06T 7/20; G06V 10/764; G06V 20/40; G08B 13/196

(52) U.S. Cl. CPC G06V 20/52; G06T 7/20; G06V 10/764; G06V 20/40; G08B 13/19606; G08B 13/19613; G06T 2207/10016; G06T 2207/30232

(57) ABSTRACT

A process of providing a security alert in response to an object crossing a security perimeter. In operation, an electronic computing device obtains and analyzes a video stream captured corresponding to a field of view of a camera covering a security perimeter of an area under surveillance. The device determines that a shadow detected in the video stream is cast by an object existing outside of the field of view of the camera. The device determines that the object is moving based on characteristics of the shadow detected in the video stream. The device determines whether the object has crossed the security perimeter based at least in part on the current position of the light source and one or more characteristics of the shadow detected in the video stream. The device provides a security alert in response to determining that the object has crossed the security perimeter.

### BACKGROUND

Surveillance cameras are widely used by public-safety agencies and enterprises to enhance security and monitor activities. Cameras operate by capturing images and video within their field of view, typically defined by their lens design, sensor capabilities, and positioning. While video cameras have become increasingly sophisticated, offering higher resolutions, enhanced optics, and low-light performance, they are inherently limited by their fixed or adjustable field of view.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device shown in FIG. 1 in accordance with some embodiments.

FIG. 3 illustrates a flowchart of a process for providing a security alert in response to an object crossing a security perimeter in accordance with some embodiments.

FIG. 4 illustrates positions of shadows cast by different objects relative to different positions of a light source in accordance with some embodiments.

FIG. 5 illustrates an example of a mathematical formula used to compute a position of a light source responsible for casting a shadow of an object in accordance with some embodiments.

FIG. 6 illustrates a process for defining a virtual security perimeter within a field of view of a camera in accordance with some embodiments.

FIG. 7A illustrates an example scenario in which an object existing outside of a field of view of a camera is determined as not having crossed a security perimeter when a shadow cast by the object has not crossed an actual security perimeter or a virtual security perimeter defined within the field of view of the camera.

FIG. 7B illustrates an example scenario in which an object existing outside of a field of view of a camera is determined as not having crossed a security perimeter when a shadow cast by the object has crossed an actual security perimeter but not a virtual security perimeter defined within the field of view of the camera.

FIG. 7C illustrates an example scenario in which an object existing outside of a field of view of a camera is determined as having crossed a security perimeter when a shadow cast by the object has crossed an actual security perimeter as well as a virtual security perimeter defined within the field of view of the camera.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, surveillance cameras are limited in their ability to monitor areas beyond their field of view. This limitation becomes particularly critical when there is a need to monitor objects or events that occur outside the observable range of the cameras. Objects moving beyond the camera's field of view cannot be reliably detected or tracked, resulting in security blind spots and limited situational awareness. Furthermore, flying objects such as drones, helicopters, balloons, paragliders, or unmanned aerial vehicles (UAVs) present unique challenges as they often approach or cross security perimeters from spaces not covered by cameras. There have been documented incidents of such objects illegally breaching borders or restricted zones, highlighting the need for early detection and rapid response even when initial movements occur beyond a camera's direct line of sight. Accordingly, there is a need for a technical solution that extends the capability of video cameras to detect, track, and respond to objects crossing or attempting to cross a security perimeter even when the object itself is not observable within the cameras' field of view. More particularly, there is a need for a technical solution for providing a security alert in response to identifying an object crossing a security perimeter even when the object is existing outside of the camera's field of view.

One embodiment provides a method of providing a security alert in response to an object crossing a security perimeter. The method comprises: obtaining, at an electronic computing device, a video stream captured corresponding to a field of view of a camera, the field of view covering a security perimeter of an area under surveillance; detecting, at the electronics computing device; a shadow in the video stream based on analyzing the video stream using a video analytics engine; determining, at the electronic computing device, that the shadow is cast by an object existing outside of the field of view of the camera; determining, at the electronic computing device, that the object existing outside of the field of view of the camera is moving based on one or more characteristics of the shadow detected in the video stream; identifying, at the electronic computing device, a current position of a light source responsible for casting the shadow; determining, at the electronic computing device, whether the object has crossed the security perimeter based at least in part on the current position of the light source and the one or more characteristics of the shadow detected in the video stream; and providing, at the electronic computing device, a security alert in response to determining that the object existing outside of the field of view of the camera has crossed the security perimeter.

Another embodiment provides an electronic computing device comprising a communications interface and an electronic processor communicatively coupled to the communications interface. The electronic processor is configured to: obtain, via the communications interface, a video stream captured corresponding to a field of view of a camera, the field of view covering a security perimeter of an area under surveillance; detect a shadow in the video stream based on analyzing the video stream using a video analytics engine; determine that the shadow is cast by an object existing outside of the field of view of the camera; determine that the object existing outside of the field of view of the camera is moving based on one or more characteristics of the shadow detected in the video stream; identify a current position of a light source responsible for casting the shadow; determine whether the object has crossed the security perimeter based at least in part on the current position of the light source and the one or more characteristics of the shadow detected in the video stream; and provide a security alert in response to determining that the object existing outside of the field of view of the camera has crossed the security perimeter.

Each of the above-mentioned embodiments will be discussed in more detail below, starting with example system and device architectures of the system in which the embodiments may be practiced, followed by an illustration of processing blocks for achieving an improved technical system, method, and device of providing a security alert in response to an object crossing a security perimeter. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

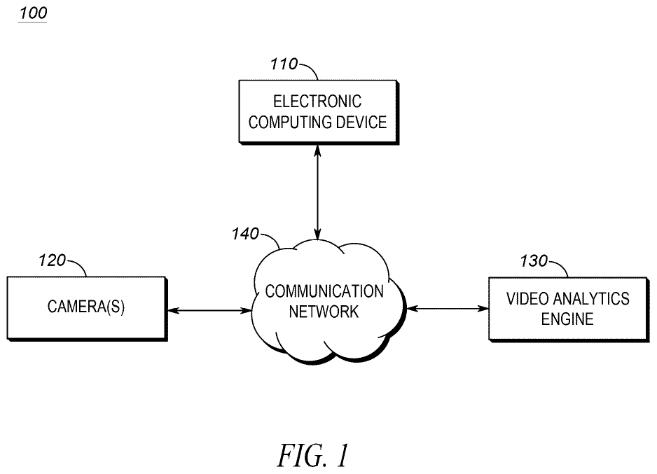

Referring now to the drawings, and in particular FIG. 1, a system 100 is shown including an electronic computing device 110, one or more cameras 120, a video analytics engine 130, and a communication network 140. The electronic computing device 110 is any computing device configured to analyze video streams captured by the camera 120 for the purpose of providing security alerts in response to determining that an object existing outside of a field of view of the camera 120 has crossed a security perimeter of an area under surveillance. The term “security perimeter” refers to a defined boundary or area established to protect a location, facility, or region from unauthorized access, breaches, or security threats. The security perimeter may encompass physical barriers, virtual boundaries, or monitored zones and is equipped with surveillance systems supported by the electronic computing device 110 and the one or more cameras 120 to monitor for objects crossing or attempting to cross the security perimeter. The electronic computing device 110 may be implemented as a standalone electronic device or alternatively integrated into one or more other devices (e.g., camera(s) 120) in the system 100. In accordance with some embodiments, the electronic computing device 110 is a computing device specifically authorized by an agency to detect and track objects that are existing outside of a field of view of the camera 120. An agency is an organizational entity that is tasked with the responsibility of monitoring and securing an area. In some embodiments, an agency may represent a private enterprise organization such as press, media, utilities, oil/gas, electric, transportation, private security, or other business. In other embodiments, an agency may refer to public agencies such as border control authorities, national security agencies, law enforcement agencies, transportation security agencies, and defense and military agencies.

The camera 120 includes any video recording device that is configured to capture a video stream corresponding to a field of view of the camera 120. The field of view refers to the extent of the observable area that the camera 120 can capture at any given moment. The field of view may be fixed or adjustable depending on the type of camera 120 and its features. As an example, the field of view of the camera 120 may be defined by lens (e.g., lens focal length) and sensor characteristics (sensor size) of the camera 120. Although only one camera 120 is shown, the system 100 may include any number of cameras 120 that may be deployed in any number of locations to monitor the area. In accordance with some embodiments, the camera 120 includes a fixed surveillance camera that is deployed for monitoring an area under surveillance. The camera 120 may be mounted in any suitable position to monitor the security perimeter of an area under surveillance. The embodiments described herein can also be similarly implemented for cameras other than fixed surveillance cameras, such as vehicular cameras, mobile cameras, drone cameras, and other portable cameras. The camera 120 may be owned, controlled, or operated by one or more agencies that may also be responsible for monitoring and securing the area.

The video analytics engine 130 is implemented in computing devices selected from one or more of edge computing devices and cloud computing devices that are configured to run video analytics on video streams captured by the camera 120. For instance, when implemented at an edge computing device, the video analytics engine 130 may be housed in the same premise (e.g., same building or facility), or otherwise coupled to the same communication network (e.g., a local area network), as the camera 120. Alternatively, the video analytics engine 130 may be implemented on cloud computing devices that may comprise any number of computing devices (including the electronic computing device 110) and servers, and may include any type and number of resources, including resources that facilitate communications with and between servers, storage by the servers that are hosted remotely over one or more communication networks 140. The cloud computing devices may include any resources, services, and/or functionality that can be utilized through an on-demand or subscription service for executing video analytics tasks.

In accordance with some embodiments, the electronic computing device 110 uses the video analytics engine 130 to analyze video streams captured by the camera 120. The video analytics engine 130 is configured to access video streams captured by the camera 120 and to analyze the video streams to determine properties or characteristics of the captured video streams and/or of persons, objects, or events found in the scene represented by the video streams. In the embodiments described herein, the video analytics engine 130 is additionally configured to detect shadows in the video streams captured by the camera 120. Based on the determinations made, the video analytics engine 130 may further output metadata providing information indicating the presence of a shadow in a video stream captured by the camera 120. The metadata includes, among other things, one or more characteristics of the shadow that indicate shape, size, trajectory, moving direction, or positioning (e.g., relative to a security perimeter defined for the monitored area) of the shadow. The metadata may also further include information indicating whether the shadow is cast by an object existing within the field of view of the camera 120 or whether the shadow is cast by an object existing outside (i.e., not detectable by the camera 120) of the field of view of the camera 120. The electronic computing device 110 uses, among other things, the one or more characteristics of the shadow to determine whether the object casting the shadow has crossed the security perimeter.

The electronic computing device 110, the camera 120, and the video analytics engine 130 may each include one or more wired or wireless communication interfaces for communicating with other devices operating in the system 100 via the communication network 140. The communication network(s) 140 may include wireless and/or wired connections. For example, the communication network 140 may be implemented using a wide area network, such as the Internet, a local area network, such as a Wi-Fi network, and personal area or near-field networks, for example a Bluetooth™ network. Portions of the communications network may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof.

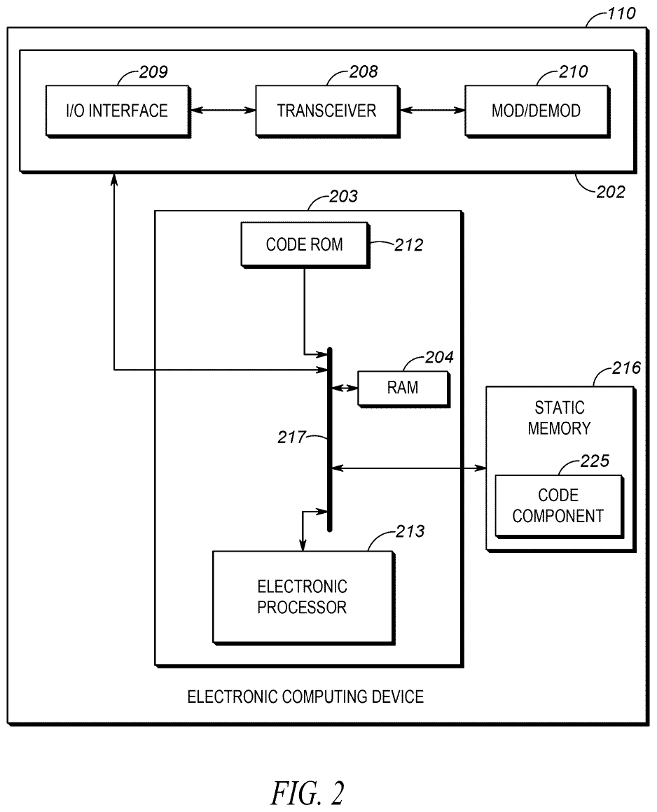

FIG. 2 is an example functional block diagram of an electronic computing device 110 operating within the system 100 in accordance with some embodiments. The electronic computing device 110 may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 can be implemented within the camera 120, the video analytics engine 130, or other devices shown in FIG. 1. While FIG. 2 represents an electronic computing device 110 described above with respect to FIG. 1, the electronic computing device 110 may include fewer or additional components in configurations different from that illustrated in FIG. 2.

As shown in FIG. 2, the electronic computing device 110 includes a communications interface 202 coupled to a common data and address bus 217 of a processing unit 203. The communications interface 202 sends and receives data to and from other devices in the system 100. The communications interface 202 may include one or more wired and/or wireless input/output (I/O) interfaces 209 that are configurable to communicate with other devices in the system 100. For example, the communications interface 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications interface 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications interface 202.

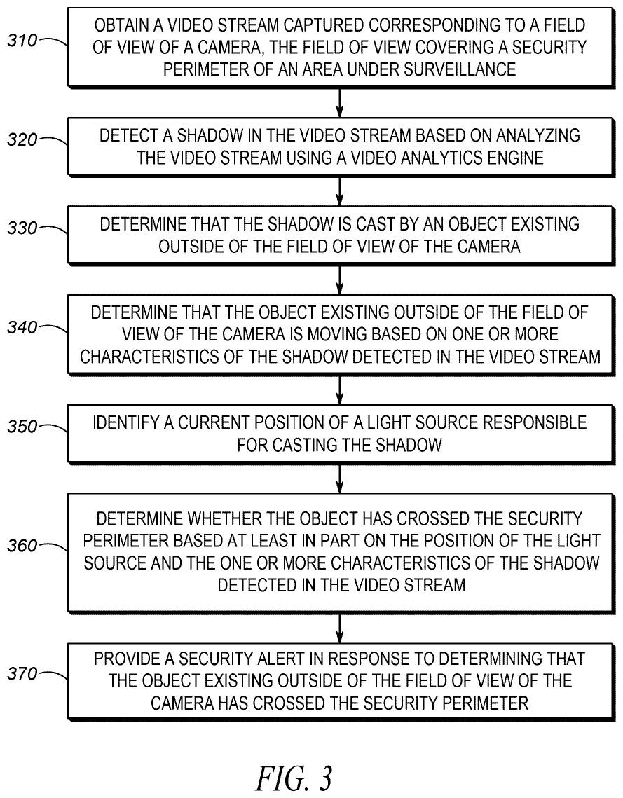

Static memory 216 may store operating code 225 for the electronic processor 213 that, when executed, performs one or more of the blocks set forth in FIG. 3, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may further store information required for the purpose of providing a security alert in response to an object crossing the security perimeter. As an example, the static memory 216 stores video streams captured by the camera 120 and metadata (e.g., information indicating the presence of shadow and one or more characteristics of the shadow) output by the video analytics engine 130 based on processing of the video streams captured by the camera 120.

Turning now to FIG. 3, a flowchart diagram illustrates a process 300 for providing a security alert in response to an object crossing a security perimeter. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. The electronic computing device 110 shown in FIG. 1 and/or FIG. 2, and embodied as a singular computing device or distributed computing device may execute process 300 via an electronic processor 213.

The electronic computing device 110 may execute the process 300 at power-on, at some predetermined periodic time period thereafter, in response to a trigger raised locally at the electronic computing device 110 via an internal process or via an input interface or in response to a trigger from an external device to which the electronic computing device 110 is communicably coupled, among other possibilities.

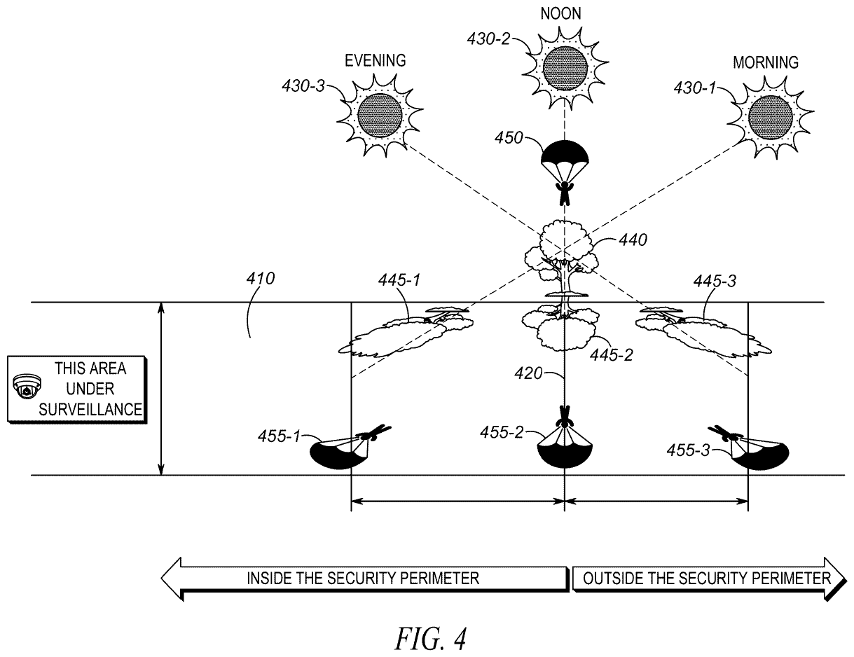

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well. The process 300 is also further described herein with reference to FIGS. 4-7.

At block 310, the electronic computing device 110 obtains a video stream captured corresponding to a field of view of a camera 120, where the field of view of the camera 120 covers a security perimeter of an area under surveillance. The electronic computing device 110 may obtain the video streams either directly from the camera 120 or via another device that has access to the video streams captured by the camera 120. In accordance with some embodiments, the electronic computing device 110 obtains and analyzes video streams in real-time i.e., as soon as the video stream is captured by the camera 120.

While the field of view of the camera 120 covers a security perimeter of an area under surveillance, the camera's field of view covers a limited vertical space above the security perimeter. To illustrate this limitation in the camera's field of view, assume an area 410 is under surveillance by one or more cameras 120 as shown in FIG. 4. The field of view of the camera 120 covers a security perimeter 420 defined for the area 410. The security perimeter 420 may be a physical or virtual boundary that is defined within the area 410. In accordance with embodiments, the camera 120 may be operated by an agency that is also responsible for protecting the area 410 under surveillance. Protecting the area 410 may include monitoring for objects crossing or attempting to cross the security perimeter 420 defined for the area 410. In the example shown in FIG. 4, the field of view of the camera 120 may fully cover a horizontal area relative to the security perimeter 420, providing visibility for the camera 120 to detect objects that are crossing the security perimeter 420 (i.e., from a location outside the security perimeter 420) via the ground space. However, most cameras including the camera 120 has a fixed or constrained vertical field of view, meaning the camera 120 can capture only a limited slice of vertical space over the security perimeter 420. This limitation in the camera's vertical field of view can lead to blind spots with respect to the vertical space above the security perimeter of the area 410 where objects existing higher than the vertical field of view of the camera 120 cannot be detected by the camera 120. In other words, while the camera's horizontal field of view can cover objects that are crossing into the security perimeter 420, the camera's vertical field of view cannot cover certain objects (e.g., flying object 450) crossing into the security perimeter 420 from a vertical space that is outside of the camera's vertical field of view. To address this limitation, the embodiments described herein rely on shadows cast by such objects attempting to cross the security perimeter 420 from a height that is outside of the camera's vertical field of view.

At block 320, the electronic computing device 110 detects a shadow in the video stream based on analyzing the video stream using a video analytics engine 130. As an example, briefly referring to FIG. 4, the electronic computing device 110 uses the video analytics engine 130 to analyze a video stream captured corresponding to the area 410 under surveillance and further detects the presence of shadows 445, 455 in the video stream. The video analytics engine 130 may apply a combination of image processing techniques and machine learning algorithms to detect the presence of shadows in the video streams. In accordance with some embodiments, the video analytics engine 130 applies rules or machine learning classifiers, which leverages spatial and temporal data, to distinguish shadows and actual objects detected in the video stream. The video analytics engine 130 may analyze the video streams and extract features such as intensity, texture, or color information that could indicate the presence of shadows. For instance, shadows tend to be usually darker than their surroundings, have soft edges, and maintain the texture of the surface they are cast upon. The video analytics engine 130 may evaluate intensity levels of pixels and color shifts to distinguish shadows from objects. The video analytics engine 130 may detect the presence of shadows in the video streams by analyzing portions of the scene where the texture is consistent with the background but the luminance is lower. The video analytics engine 130 may analyze geometric patterns of objects detected in the video streams to detect the presence of shadows as shadows exhibit predictable geometrical patterns in relation to different positions of the light source. The video analytics engine 130 may also track movement patterns and speed of objects detected in the video streams to detect the presence of shadows based on their relative motion as shadows move differently from the objects casting them. The video analytics engine 130 is further configured to iteratively learn from detection feedback, employing machine learning models to refine the shadow detection process and minimize false positives across diverse lighting conditions and complex scenes. The video analytics engine 130 is also continuously trained to increase the accuracy of detection of shadows and objects by improving clarity of images (e.g., by adjusting or correcting brightness or contrast) captured in the video streams. In accordance with some embodiments, the video analytics engine 130 is trained using any appropriate machine learning model known in the art, including, but not limited to, convolution neural networks, inductive logic programming, support vector machines, random forests, cascade classifiers, decision trees, bayesian networks, sparse dictionaries, and genetic algorithms.

At block 330, the electronic computing device 110 determines that the shadow detected at block 320 is cast by an object that is existing outside of the field of view of the camera 120. In accordance with some embodiments, the electronic computing device 110 analyzes the video stream using the video analytics engine 130 to detect objects other than shadows that are appearing within the video stream. The video analytics engine 130 may use one of several techniques mentioned above to distinguish objects from shadows. The electronic computing device 110 then determines whether one or more of the detected objects (i.e., objects other than the shadows detected in the video stream) is responsible for casting the detected shadow. In one embodiment, the electronic computing device 110 may compare the characteristics of the shadow, for example, shadow shape, size, pattern, or moving direction with the characteristics of other objects detected in the video stream to determine whether one or more of the other objects detected in the video stream is responsible for casting the shadow. If the characteristics of the shadow do not correlate with any of the other objects detected in the video stream, then the electronic computing device 110 determines that the detected shadow is cast by an object that is existing outside of the field of view of the camera 120. In other words, the electronic computing device 110 determines that the shadow is cast by an object that is outside the observable range of the camera 120. As an example, referring to FIG. 4, while the electronic computing device 110 is able to detect the presence of a shadow 455 within the camera's field of view, an object 450 (e.g., paraglider) which is responsible for casting the shadow 455 is existing at a vertical space that is outside of the camera's field of view and therefore the object 450 itself is not directly visible or detectable from the video stream captured by the camera 120. The embodiments described herein rely on detection of a shadow cast by an object (e.g., object 450) existing outside of the camera's field of view to estimate a position of the object and to further determine whether the object has crossed the security perimeter, for example, from a vertical space beyond the camera's field of view.

At block 340, the electronic computing device 110 determines that the object existing outside of the field of view of the camera 120 is moving based on one or more characteristics of the shadow detected in the video stream. In one embodiment, the electronic computing device 110 determines that the object is moving based on changes in the characteristics of the shadow detected between consecutive images captured over a period of time. In this embodiment, the electronic computing device 110 establishes a baseline by analyzing the shadows in the initial frames and extracting the characteristics of the shadows including one or more of shape, size, position, and intensity of the shadow. Then, the electronic computing device 110 compares the current shadow characteristics (e.g., extracted from additional sequence of video frames) with those of the baseline. The electronic computing device 110 may determine that the object responsible for casting the shadow is moving based on any threshold level of changes detected, for example, in one or more of length, direction, sharpness, or opacity. The electronic computing device 110 may also use techniques such as background subtraction, where the static background is subtracted from each frame to isolate changes, or edge detection, to identify shifts in the contours of shadows. The electronic computing device 110 may also incorporate filters to account for changes in natural lighting or other environmental factors that might otherwise be mistaken for movement. In accordance with some embodiments, the electronic computing device 110 provides a security alert only for those objects that are determined to be moving, for example, in a direction towards the security perimeter of an area under surveillance.

At block 350, the electronic computing device 110 identifies a current position of a light source responsible for casting the shadow detected at block 320. The light source responsible for casting the shadow may include a natural light source such as the sun and/or an artificial light source such as light emitting diodes or fluorescent lights placed in positions near the security perimeter or integrated with the camera 120. In the case of a natural light source, the electronic computing device 110 identifies a current position of the light source by identifying a time and date during which the shadow is detected and further estimating the position of the light source as a function of historical data corresponding to different positions of the light source at different times and dates for geographical coordinates associated with the area under surveillance. For instance, it is possible to determine the current position of a natural light source such as the sun based on historical data captured corresponding to different positions of the sun at different times and dates. The historical data can be captured, for example, by placing a reference object (or identifying a reference object already existing in proximity to the security perimeter 420) and observing (e.g., by capturing and analyzing video streams using the video analytics engine 130) different positions of the shadow cast by the reference object as the position of the light source changes as a function of the time and date. In accordance with some embodiments, the historical data can be captured by operating the camera 120 in training mode.

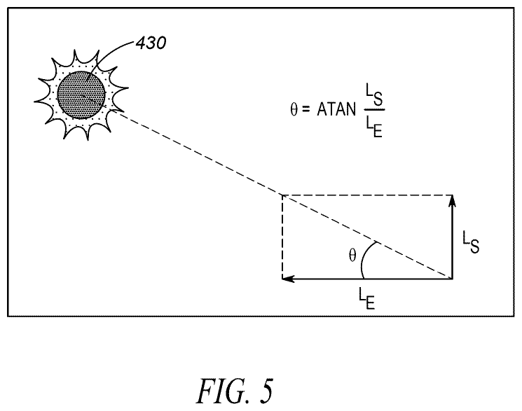

As an example, referring to FIG. 4, a reference object 440 (e.g., tree) is shown as being placed in close proximity to the security perimeter 420. The electronic computing device 110 then captures historical data by observing the positions of the shadow cast by the reference object 440 at different time/day intervals. In the example shown in FIG. 4, during morning time, when the light source 430 is at a position 430-1, a shadow 445 is cast by the reference object 440 at a location 445-1 within the field of view of the camera 120. In this case, the electronic computing device 110 computes a distance between the location 445-1 at which the shadow 445 cast by the reference object 440 is placed under the detected position 430-1 of the light source 430 and a location at which the reference object 440 is placed in proximity to the security perimeter. During noon time, when the light source 430 is at a position 430-2, a shadow 445 is cast by the reference object 440 at a location 445-2. In this case, the electronic computing device computes a distance between the location 445-2 at which the shadow 445 cast by the reference object 440 is placed under the detected position 430-2 of the light source 430 and a location at which the reference object 440 is placed in proximity to the security perimeter 420. During evening time, when the light source 430 is at a position 430-3, a shadow 445 is cast by the reference object 440 at a location 445-3. In this case, the electronic computing device 110 computes a distance between the location 445-3 at which the shadow 445 cast by the reference object 440 is placed under the detected position 430-2 of the light source 430 and a location at which the reference object 440 is placed in proximity to the security perimeter 420. The electronic computing device 110 accordingly captures and stores such historical data indicating different locations of the shadow cast by the reference object at different times and days and a corresponding distance estimated between the shadow 445 and the reference object 440. The electronic computing device 110 also stores data about height of the reference object 440 used for observing the locations of the shadows 445 cast by the reference object 440. The electronic computing device 110 is then able to estimate a current position of the light source by retrieving a dataset for a similar time and day indicating a computed distance between the position of the shadow and the reference object. As an example, FIG. 5 illustrates a mathematical formula that can be used to compute a current position of a light source 430 (e.g., sun) based on historical data captured corresponding to different detected positions of the light source 430. More particularly, a current position of the light source 430 is calculated using a mathematical formula θ=atan(L_{S}/L_{E}), where θ represents an angle of the light source 430 relative to the ground surface, L_{S} represents a height of the reference object 440 relative to the ground surface, and L_{E} represents a distance between a location of the shadow 445 cast by the reference object 440 and a location of the reference object. The electronic computing device 110 may similarly detect positions of artificial light sources that may be responsible for casting the shadow detected at block 320. The electronic computing device 110 may use any method known in the art for identifying a current position of a light source that is responsible for casting a shadow detected within a field of view of a camera 120. FIG. 4 also further illustrates how the shadow 455 cast by an unidentified object (e.g., object 450 existing outside of the camera's field of view) moves to different locations relative to different positions of the light source 430. As shown in FIG. 4, the shadow 455 is detected at a location 455-1 in relation to a position 430-1 of the light source 430 during morning time. The shadow 455 is detected at a location 455-2 in relation to a position 430-2 of the light source 430 during noon time. The shadow 455 is detected at a location 455-3 in relation to a position 430-3 of the light source 430 during evening time.

Returning to FIG. 3, at block 360, the electronic computing device 110 determines whether the object has crossed the security perimeter based at least in part on the position of the light source and the one or more characteristics of the shadow detected in the video stream. In accordance with some embodiments, in order to determine whether the object has crossed the security perimeter (also referred herein as an actual security perimeter) the electronic computing device 110 defines or establishes a virtual security perimeter (i.e., in addition to the actual security perimeter previously defined by the agency) within the field of view of the camera 120. As can be appreciated by a person skilled in the art, a shadow crossing an actual security perimeter does not necessarily mean that the shadow is cast by an object that also has crossed the security perimeter. It is possible for a shadow to be cast on a horizontal space (e.g., a space covered by the camera's field of view) that is within the security perimeter while the object responsible for casting the shadow is existing in a vertical space (e.g., a space not covered by the camera's field of view) that is outside of the security perimeter. In other words, the electronic computing device 110 cannot be programmed to conclude that the object has crossed the security perimeter merely because the shadow cast by the object has crossed the security perimeter. The embodiments described herein therefore rely on a virtual security perimeter to determine whether the object (which is detected to be existing outside of the field of view of the camera 120) has crossed the security perimeter.

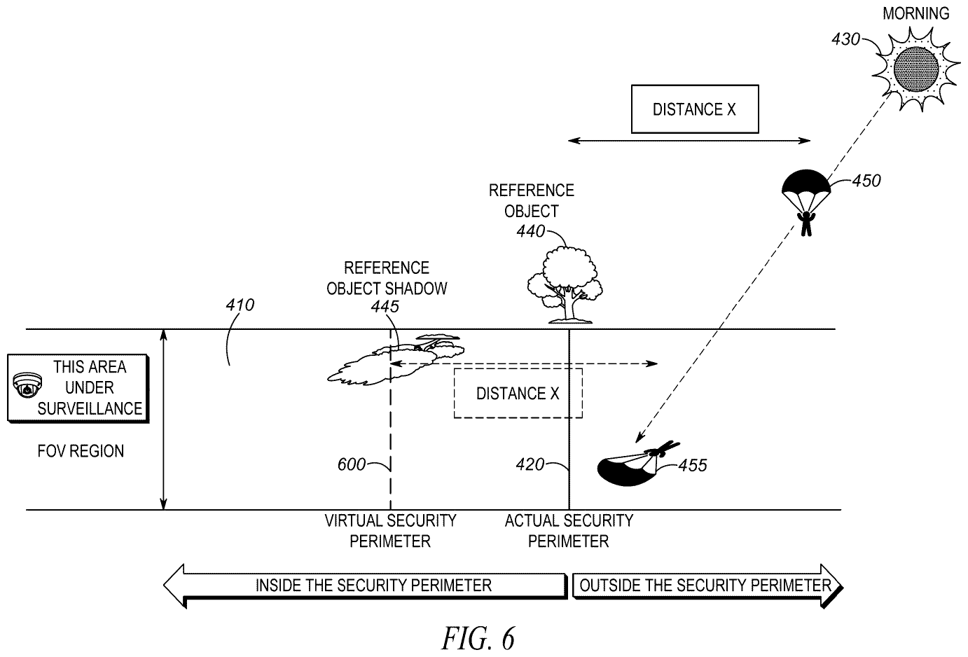

Referring to FIG. 6, a process for defining a virtual security perimeter within a field of view of a camera 120 is shown in accordance with some embodiments. In one embodiment, the camera 120 is operated in a training mode during which a reference object 440 is placed or identified in proximity to the security perimeter 420 and a corresponding location of a shadow 445 cast by the reference object 440 at different positions of the light source 430 (e.g., as shown in FIG. 4) is extracted and further stored at the electronic computing device 110. During regular operation i.e. when the surveillance system including the electronic computing device 110 and the camera 120 is deployed for detecting objects that are crossing the security perimeter and when the electronic computing device 110 subsequently detects a shadow as described with reference to block 320, the electronic computing device 110 retrieves a dataset indicating the position or location of the shadow 445 cast by the reference at a similar time, date, and geographical location as the current time, date, and geographical location. The electronic computing device 110 then estimates a distance ‘X’ between a location at which the shadow 445 cast by the reference object 440 is detected (e.g., as retrieved from the dataset captured during the training mode) and a location at which the shadow cast by an unidentified object 450 (i.e., object 450 determined to be existing outside of the field of view of the camera 120) is detected (i.e., as detected at block 320 during the camera's regular operational mode). The electronic computing device 110 then defines a virtual security perimeter 600 within the field of view of the camera 120 as a function of the estimated distance ‘X’. In accordance with some embodiments, the electronic computing device 110 continues to update the position of the virtual security perimeter 600 within the field of view as the estimated distance between a location of the shadow 445 cast by the reference object 440 and a location of the shadow 455 cast by the unidentified object 450 changes relative to a change in position of the light source. Accordingly, the electronic computing device 110 defines a virtual security perimeter at any given moment as a function of a distance ‘X’ estimated between the location (as detected during the training mode for a current position of the light source) of the shadow 445 cast by the reference object 440 and the location of the shadow 455 cast by the object 450. In this embodiment, the dataset (i.e., capturing different positions of the shadow cast by the reference object 440 in relation to different positions of the light source 430) captured during the training mode is stored at a database that is accessible by the electronic computing device 110. After storing the dataset, the reference object 440 placed during the training mode may be removed or ignored as the reference object 440 is no longer required for computing the distance ‘X’ or for defining the virtual security perimeter. In another embodiment, instead of operating the camera 120 in training mode, a reference object 440 is placed in proximity to the security perimeter 420 (or alternatively one or more reference objects placed in proximity to the security perimeter are identified) during all times of the camera operation. In this embodiment, since a reference object is placed or identified at all times during the camera operation, a shadow 445 cast by the reference object 440 can be detected in the video streams captured by the camera 120. Furthermore, in this embodiment, the electronic computing device 110 computes a distance ‘X’ based on the real-time locations of the shadow 445 cast by the reference object 440 and the shadow 445 cast by the unidentified object 450 existing outside of the field of view of the camera 120. The electronic computing device 110 then defines and continues to update the virtual security perimeter in real-time based on the computed distance. In these embodiments, it is assumed that the distance ‘X’ calculated between the locations of the shadow 445 cast by the reference object 440 and the shadow 455 cast by the object 450 would mirror the distance between a location at which the security perimeter 420 is placed and a location (e.g., at a vertical space beyond the camera's vertical field of view) at which the object 450 casting the shadow 455 is existing outside the camera's field of view. As can be appreciated by a person skilled in the art, it is possible for the virtual security perimeter 600 to be defined at the same position as the actual security perimeter previously set by the agency in some cases. For example, briefly referring to FIG. 4, it can be seen that the location 455-2 of the shadow 455 cast by the unidentified object 450 aligns with the position of the security perimeter 420 during noon time when the position of the light source 430 also aligns with the position of the security perimeter 420.

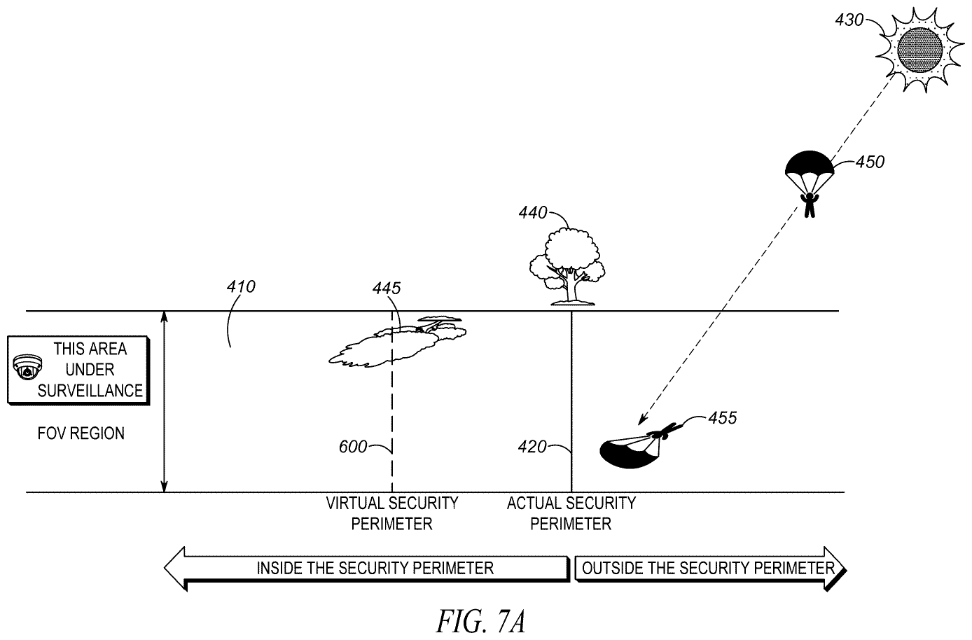

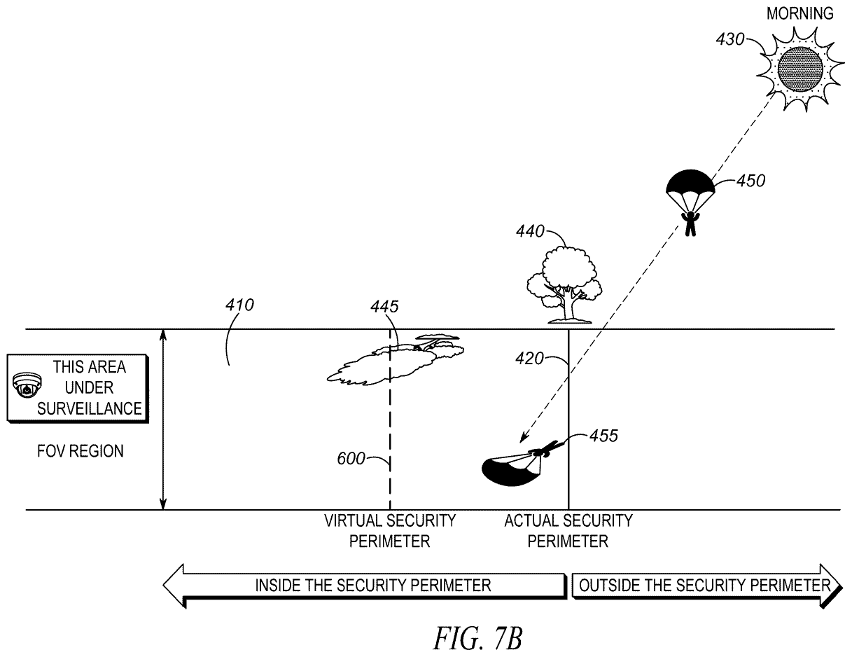

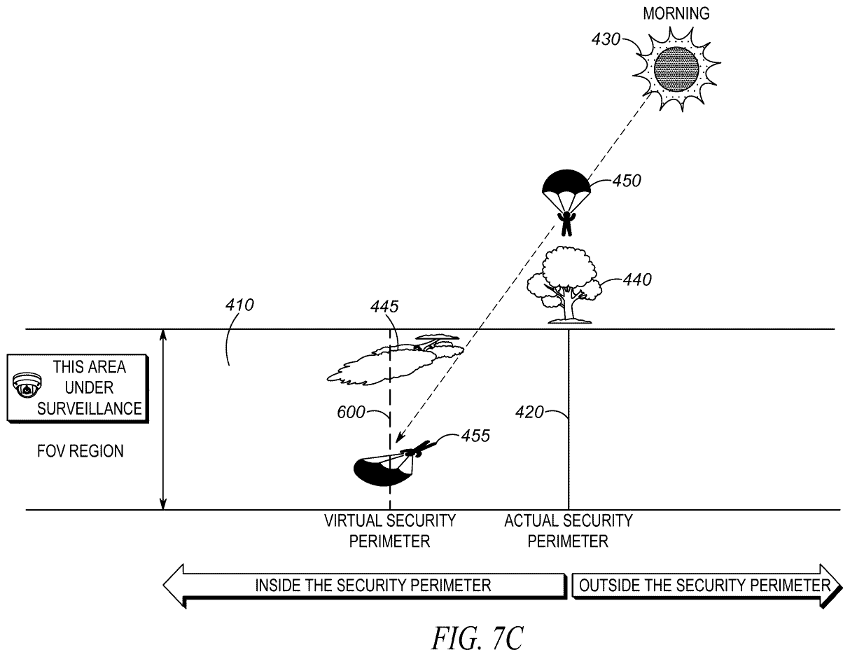

In accordance with some embodiments, the electronic computing device 110 is programmed to determine that the object has crossed the security perimeter when the shadow has crossed the virtual security perimeter defined within the field of view of the camera 120. Additionally, the electronic computing device 110 is programmed to determine that the object has not crossed the security perimeter when the shadow has not crossed the virtual security perimeter defined within the field of view. The electronic computing device 110 may determine whether the shadow has crossed or not crossed the virtual security perimeter by analyzing the position of the shadow detected at block 320 and further determining whether the position falls outside or inside of the virtual security perimeter defined within the field of view of the camera 120. If the position of the detected shadow is outside of the virtual security perimeter, then the electronic computing device 110 determines that the detected shadow has not crossed the virtual security perimeter. An example scenario is illustrated in FIG. 7A in which an object existing outside of a field of view of a camera 120 is determined as not having crossed a security perimeter when a shadow cast by the object has not crossed an actual security perimeter 420 or a virtual security perimeter 600 defined within the field of view of the camera 120. Another example scenario is illustrated in FIG. 7B in which an object 450 existing outside of a field of view of a camera 120 is determined as not having crossed a security perimeter when a shadow cast by the object has crossed an actual security perimeter but not a virtual security perimeter defined within the field of view of the camera 120. On the other hand, if the position of the detected shadow is inside or overlapping with the virtual security perimeter, then the electronic computing device 110 determines that the shadow has crossed the virtual security perimeter. An example scenario is illustrated in FIG. 7C in which an object 450 existing outside of a field of view of a camera 120 is determined as having crossed a security perimeter when a shadow cast by the object has crossed a virtual security perimeter defined within the field of view of the camera 120. In this example, while the object is determined to have crossed the actual security perimeter based on the shadow crossing the virtual security perimeter, the object itself may be still outside of the observable range (e.g., by existing at a vertical space above the security perimeter beyond the camera's vertical field of view) of the camera 120 and therefore may remain invisible in any video stream captured corresponding to the camera's field of view. The embodiments described herein relies on the positions of the shadow cast by such objects to track and detect objects crossing or attempting to cross the security perimeter.

At block 370, the electronic computing device 110 provides a security alert when the electronic computing device 110 determines, at block 360, that the object existing outside of the field of view of the camera 120 has crossed the security perimeter. In one embodiment, prior to providing the security alert, the electronic computing device 110 determines whether the object that is determined to have crossed the security perimeter presents a security risk. In this embodiment, the electronic computing device 110 provides a security alert only when it is determined that the object presents a security risk. The electronic computing device 110 determines that an object presents a security risk based on an object type represented by the object. The electronic computing device 110 may identify an object type represented by the object based on analyzing one or more characteristics of the shadow detected in the video stream using the video analytics engine 130. The object type may include, but not be limited to, drones, unmanned aerial vehicles, recreational balloons, spy balloons, kites, birds, paragliders, aircrafts, rockets, projectiles, and blimps. In one embodiment, the electronic computing device 110 may compare characteristics such as shape, size, pattern, moving direction, trajectory, and position of a shadow with predefined characteristics associated with a list of predefined objects to identify an object type represented by an object. Furthermore, the electronic computing device 110 may also store a list of objects and a level of security risk associated with each object included in the stored list. As an example, assume the electronic computing device 110 identifies that the object type represented by the object crossing the security perimeter is a bird. In this example, the electronic computing device 110 may not provide any security alert when a level of security risk associated with an object type ‘bird’ is lower than a threshold. As another example, assume the electronic computing device 110 identifies that the object type represented by the object is a drone. In this example, the electronic computing device 110 provides a security alert when a level of security risk associated with an object type ‘drone’ is higher than a threshold level. In one embodiment, if there is no correlation between the characteristics of the shadow and characteristics of any of the object types predefined in the stored list, then the electronic computing device 110 still provides a security alert indicating that an unknown or unidentified object has crossed the security perimeter. Furthermore, in accordance with some embodiments, the electronic computing device 110 uses environmental data such as wind direction captured corresponding to the area under surveillance to differentiate between an object that has intentionally crossed the security perimeter and an object that has unintentionally crossed the object. In this embodiment, the electronic computing device 110 determines that the object has intentionally crossed the security perimeter when one or more characteristics of the shadow indicate that the object is moving in a direction that is against the wind direction.

The electronic computing device 110 may provide a security alert via an electronic output indicating that an object has crossed the security perimeter defined by the agency. The electronic output may take the form of text, image, audio, or video. The electronic computing device 110 may provide the electronic output on a corresponding visual and/or audio output device. For example, the visual and/or audio output device may include an electronic display and/or a speaker implemented on one or more computing devices (e.g., portable radio, dispatch console etc.) associated with security officers employed by the agency. The electronic output in the form of text, image, or video may be rendered via the electronic display of the visual and/or audio output device. The electronic output in the form of audio is played back via the speaker of the one or more computing devices associated with the security officers employed by the agency. The security alert may include information identifying the object type represented by the object crossing the security perimeter, a level of security risk associated with the object type, and whether the object has intentionally crossed the security perimeter.

In accordance with some embodiments, the electronic computing device 110 provides a security alert even when the object has not yet crossed the security perimeter. As an example, the electronic computing device 110 provides a security alert when the object is moving in a direction toward the security perimeter and is within a predefined threshold distance from the security perimeter. In this embodiment, the security alert may further include information identifying a level of security risk presented by an object type represented by the object and a time to be taken by the object to potentially cross the security perimeter. The electronic computing device 110 estimates a time to be taken by the object in crossing the security perimeter based at least in part on the speed of the object. The electronic computing device 110 computes the speed of the object by analyzing the characteristics of the shadow cast by the object. For example, the electronic computing device 110 can compute the speed of the object based on a distance traversed by the shadow within the field of view of the camera 120 and a corresponding time taken by the shadow in traversing the distance.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing a security alert in response to an object crossing a security perimeter, the method comprising:
obtaining, at an electronic computing device, a video stream captured corresponding to a field of view of a camera, the field of view covering a security perimeter of an area under surveillance;
detecting, at the electronics computing device; a shadow in the video stream based on analyzing the video stream using a video analytics engine;
determining, at the electronic computing device, that the shadow is cast by an object existing outside of the field of view of the camera;
determining, at the electronic computing device, that the object existing outside of the field of view of the camera is moving based on one or more characteristics of the shadow detected in the video stream;
identifying, at the electronic computing device, a current position of a light source responsible for casting the shadow;
determining, at the electronic computing device, whether the object has crossed the security perimeter based at least in part on the current position of the light source and the one or more characteristics of the shadow detected in the video stream; and
providing, at the electronic computing device, a security alert in response to determining that the object existing outside of the field of view of the camera has crossed the security perimeter.

2. The method of claim 1, wherein the security alert includes information indicating that the object has crossed the security perimeter.

3. The method of claim 1, wherein prior to providing the security alert, the method comprising:
identifying an object type represented by the object based on one or more characteristics of the shadow detected in the video stream; and
determining that the object type presents a security risk.

4. The method of claim 3, wherein the security alert includes information identifying the object type.

5. The method of claim 1, further comprising:
determining, at the electronic computing device, that the object has not crossed the security perimeter;
determining, at the electronic computing device, a speed of the object;
estimating, at the electronic computing device, a time to be taken by the object in crossing the security perimeter based at least in part on the speed of the object; and
providing, at the electronic computing device, a security alert indicating the time to be taken by the object in crossing the security perimeter.

6. The method of claim 1, further comprising:
capturing environmental data corresponding to the area, the environmental data including wind direction; and
determining that the object has intentionally crossed the security perimeter when the one or more characteristics of the shadow detected in the video stream indicate that the object is moving against the wind direction.

7. The method of claim 1, wherein determining whether the object has crossed the security perimeter comprises:
defining a virtual security perimeter within the field of view of the camera; and
determining whether the shadow has crossed the virtual security perimeter defined within the field of view of the camera.

8. The method of claim 7, further comprising:
determining that the object has crossed the security perimeter when the shadow has crossed the virtual security perimeter defined within the field of view of the camera.

9. The method of claim 7, further comprising:
determining that the object has not crossed the security perimeter when the shadow has not crossed the virtual security perimeter defined within the field of view of the camera.

10. The method of claim 7, wherein defining the virtual security perimeter comprises:
operating the camera in a training mode to capture at least one other video stream corresponding to the field of view of the camera, the field of view of the camera covering a reference object placed in proximity to the security perimeter of the area under surveillance;
detecting, at the electronics computing device; at least one other shadow in the at least one other video stream;
determining, at the electronic computing device, that the at least one other shadow is cast by the reference object placed in proximity to the security perimeter while the camera is operated in the training mode;
estimating, at the electronic computing device, a distance between a location at which the at least one other shadow cast by the reference object is detected and a location at which the shadow cast by the object is detected;
repeating the steps of operating the camera in the training mode, detecting the at least one other shadow, determining that the at least one other shadow is cast by the reference object, and estimating the distance under a plurality of different positions of the light source that include the current position of the light source; and
defining the virtual security perimeter within the field of view as a function of the distance estimated under the identified current position of the light source.

11. The method of claim 7, wherein defining the virtual security perimeter comprises:
detecting, at the electronics computing device; a second shadow in the video stream;
determining, at the electronic computing device, that the second shadow is cast by a reference object placed in proximity to the security perimeter;
estimating, at the electronic computing device, a distance between a location at which the second shadow cast by the reference object is detected and a location at which the shadow cast by the object is detected; and
defining the virtual security perimeter within the field of view as a function of the estimated distance.

12. The method of claim 1, wherein identifying the current position of the light source comprises:
identifying a time and date during which the shadow is detected; and
estimating the position of the light source as a function of historical data captured corresponding to different detected positions of the light source at different times and dates.

13. The method of claim 12, wherein the historical data for each detected position includes a distance between a location at which a shadow cast by a reference object is placed under the detected position and a location at which the reference object is placed in proximity to the security perimeter and a height of the reference object relative to a ground surface.

14. An electronic computing device comprises:
a communications interface; and
an electronic processor communicatively coupled to the communications interface, the electronic processor configured to:
obtain, via the communications interface, a video stream captured corresponding to a field of view of a camera, the field of view covering a security perimeter of an area under surveillance;
detect a shadow in the video stream based on analyzing the video stream using a video analytics engine;
determine that the shadow is cast by an object existing outside of the field of view of the camera;
determine that the object existing outside of the field of view of the camera is moving based on one or more characteristics of the shadow detected in the video stream;
identify a current position of a light source responsible for casting the shadow;
determine whether the object has crossed the security perimeter based at least in part on the current position of the light source and the one or more characteristics of the shadow detected in the video stream; and
provide a security alert in response to determining that the object existing outside of the field of view of the camera has crossed the security perimeter.

15. The electronic computing device of claim 14, wherein the electronic processor is configured to:
identify an object type represented by the object based on one or more characteristics of the shadow detected in the video stream; and
determine that the object type presents a security risk prior to providing the security alert.

16. The electronic computing device of claim 14, wherein the electronic processor is configured to:
capture environmental data corresponding to the area, the environmental data including wind direction; and
determine that the object has intentionally crossed the security perimeter when the one or more characteristics of the shadow detected in the video stream indicate that the object is moving against the wind direction.

17. The electronic computing device of claim 14, wherein the electronic processor is configured to:
define a virtual security perimeter within the field of view of the camera; and
determine whether the shadow has crossed the virtual security perimeter defined within the field of view of the camera.

18. The electronic computing device of claim 17, wherein the electronic processor is configured to:
determine that the object has crossed the security perimeter when the shadow has crossed the virtual security perimeter defined within the field of view of the camera.

19. The electronic computing device of claim 17, wherein the electronic processor is configured to:
determine that the object has not crossed the security perimeter when the shadow has not crossed the virtual security perimeter defined within the field of view of the camera.

20. The electronic computing device of claim 17, wherein the electronic processor is configured to:
detect a second shadow in the video stream;
determine that the second shadow is cast by a reference object placed in proximity to the security perimeter;
estimate a distance between a location at which the second shadow cast by the reference object is detected and a location at which the shadow cast by the object is detected; and
define the virtual security perimeter within the field of view as a function of the estimated distance.
